(19) United States
(12) Patent Application Publication
(10) Pub. No.: US 2020/0086911 A1
(43) Pub. Date: Mar. 19, 2020

(54) MACHINE STEERING ANGLE CONTROL SYSTEM

(71) Applicant: Caterpillar Inc., Deerfield, IL (US)

(72) Inventors: Wendell Dean Stahl, Bradford, IL (US); Jeremy T. Peterson, Washington, IL (US); Kenneth Marvin Roat, Peoria, IL (US); Derrick Alexander Kofi Amanor, Peoria, IL (US); Micheal D. Valerio, Morton, IL (US)

(73) Assignee: Caterpillar Inc., Deerfield, IL (US)

(21) Appl. No.: 16/131,539

(22) Filed: Sep. 14, 2018

(51) Int. Cl. B62D 5/06; B62D 15/02; B62D 5/04; B62D 5/00

(52) U.S. Cl. CPC B62D 5/061; B62D 15/022; B62D 5/046; B62D 5/005; B62D 5/0481; B62D 5/0421

(57) ABSTRACT

A machine is disclosed. The machine may comprise a steering device configured to move along a steering position range in response to a force applied on the steering device by a machine operator. The steering device may have at least one soft stop position along the steering position range. The machine may further comprise a biasing member mechanically coupled to the steering device and configured to apply an opposing force that opposes movement of the steering device when the steering device is at or beyond the soft stop position. A magnitude of the opposing force may be sufficiently low such that the machine operator can move the steering device past the soft stop position. The machine may further comprise an electronic control device configured to determine the soft stop position based on one or more operation conditions of the machine.

### TECHNICAL FIELD

The present disclosure generally relates to machines and, more specifically, to control systems for controlling the steering angle of machines under different operation conditions.

### BACKGROUND

Work machines, such as articulated trucks, off-highway trucks, wheel loaders, and motor graders, may have ground engagement members (e.g., wheels or tracks) that turn to control the steering angle of the machine. A steering device, such as a steering wheel or joystick, may be rotatably coupled to a steering column to control the rotation angle of the ground engagement members and the machine steering angle via a steering actuator. The steering actuator may be a hydraulic actuator (e.g., hydraulic cylinders), electronic motor, or other type of actuator that actuates the rotation of the ground engagement members without a mechanical link to the steering column. An electronic control device may monitor the angle of rotation of the steering column and transmit electronic commands to the steering actuator to actuate the rotation of the ground engagement members accordingly. Thus, the angle of rotation of the steering device may dictate the angle of rotation of the ground engagement members and the machine steering angle by a relationship which may not always be linear and may vary depending on operating conditions.

Under some operation conditions, it may be desirable to temporarily limit or reduce the maximum machine steering angle of the machine to improve machine stability and safety. For example, when the machine is traveling at higher speeds, it may be desirable to temporarily reduce the maximum machine steering angle to prevent the machine from sliding. As another example, if the machine has an implement, such as a dump bed, it may be desirable to temporarily reduce the maximum machine steering angle of the machine when the implement is in an elevated position to prevent the machine from tipping over.

German patent application number DE102005038390 describes a strategy for controlling the vehicle steering angle based on vehicle driving conditions, such as driving speed. Specifically, the patent application discloses a vehicle steering system having a steering wheel that rotates a steering column which acts on a rack and steering connections to adjust the steering angle of the vehicle wheels. The steering system also includes a steering force-assisting device that applies a steering force on the steering column that counteracts the force applied on the steering wheel by the driver to limit the maximum permissible steering angle under certain driving conditions. The counteracting steering force enforces a physical limit to the rotational range of the steering wheel, and the driver is prohibited from turning the wheel past the enforced limit.

While arguably effective for its intended purpose, there is still need for improved control systems for controlling machine steering angle under different operation conditions. For instance, there is a need for more cost-effective strategies for limiting machine steering angle under different operation conditions.

### SUMMARY

In accordance with one aspect of the present disclosure, a machine is disclosed. The machine may comprise a power source, an implement configured to raise and lower a load, and ground engagement members configured to turn at a machine steering angle. The machine may further comprise a steering actuator configured to actuate turning of the ground engagement members to the machine steering angle. In addition, the machine may further comprise a steering device configured to move along a steering position range in response to a force applied on the steering device by a machine operator, and a steering position sensor configured to monitor a position of the steering device along the steering position range. Additionally, the machine may further comprise a biasing member mechanically coupled to the steering device and configured to apply an opposing force on the steering device that resists movement of the steering device when the steering device is at or beyond a soft stop position along the steering position range. A magnitude of the opposing force may be sufficiently low such that the machine operator can move the steering device past the soft stop position. Furthermore, the machine may further comprise an electronic control device in communication with the steering actuator, the steering position sensor, and the biasing member. The electronic control device may be configured to determine the soft stop position based on one or more operation conditions of the machine.

In accordance with another aspect of the present disclosure, a control system for controlling a steering angle of a machine is disclosed. The machine may include ground engagement members configured to turn at a machine steering angle. The control system may comprise a steering device configured to move along a steering position range in response to a force applied on the steering device by a machine operator, a steering position sensor configured to monitor a position of the steering device along the steering position range, a biasing member mechanically coupled to the steering device and configured to apply an opposing force on the steering device, and a steering actuator configured to actuate the turning of the ground engagement members to the machine steering angle. The steering device may be mechanically disconnected from the steering actuator. The control system may further comprise an electronic control device in communication with the steering position sensor, the steering actuator, and the biasing member. The electronic control device may be configured to determine a commanded steering angle based on the position of the steering device and to command the steering actuator to actuate the turning of the ground engagement members to the machine steering angle that corresponds with the commanded steering angle. The electronic control device may be further configured to determine a soft stop position along the steering device positional range, and to send a command to the biasing member to apply the opposing force when the steering device is at or beyond the soft stop position.

In accordance with another aspect of the present disclosure, a method for controlling a steering angle of a machine is disclosed. The machine may include a steering device configured to move along a steering position range in response to a force applied by a machine operator, and ground engagement members configured to turn at a machine steering angle. The method may comprise determining a soft stop position along the steering position range of the steering device based on one or more operation conditions of the machine, receiving a signal indicating a position of the steering device along the steering device positional range, and determining whether the position of the steering device is at or beyond the soft stop position. The method may further comprise commanding a biasing member to apply an opposing force on the steering device that opposes the movement of the steering device when the steering device is at or beyond the soft stop position. A magnitude of the opposing force may be sufficiently low such that the machine operator can move the steering device past the soft stop position. Additionally, the method may further comprise commanding the steering actuator to actuate turning of the ground engagement members to a maximum permissible machine steering angle when the steering device is at or beyond the soft stop position.

These and other aspects and features of the present disclosure will be more readily understood when read in conjunction with the accompanying drawings.

### BRIEF DESCRIPTION OF THE DRAWINGS

FIG. 1 is a side-view of a machine, constructed in accordance with the present disclosure.

FIG. 2 is a schematic representation of a steering angle control system of the machine, constructed in accordance with the present disclosure.

FIG. 3 is a schematic representation of a steering position range of a steering device of the machine, constructed in accordance with the present disclosure.

FIG. 4 is a schematic representation of soft stop positions along the steering position range of the steering device, constructed in accordance with the present disclosure.

FIG. 5 is a schematic representation similar to FIG. 3, but with the soft stop positions being asymmetrically disposed along the steering position range, constructed in accordance with the present disclosure.

FIG. 6 is a schematic representation an electronic control device of the steering angle control system and operations performed by the electronic control device, constructed in accordance with the present disclosure.

FIG. 7 is a flow chart of a series of steps that may be involved in determining the soft stop positions as performed by the electronic control device, in accordance with a method of the present disclosure.

FIG. 8 is a flow chart of a series of steps that may be involved in controlling a machine steering angle of the machine as performed by the electronic control device, in accordance with a method of the present disclosure.

### DETAILED DESCRIPTION

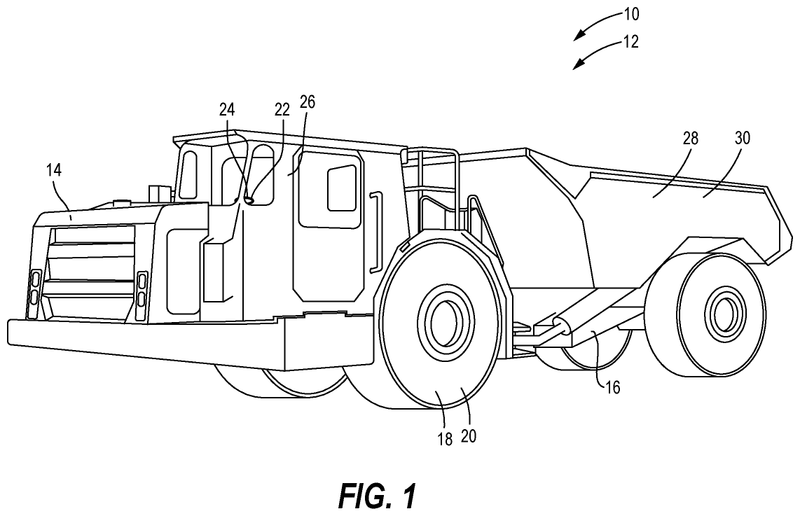

Referring now to the drawings, and with specific reference to FIG. 1, a machine 10 is shown. The machine 10 may be various types of work machines such as, but not limited to, an articulated truck 12, an off-highway truck, wheel loader, a motor grader, a dozer, as well as various other types of machines used in construction, mining, agriculture, and other such applications. The machine 10 may include a power source 14, such as an internal combustion engine, a frame 16, and ground engagement members 18, such as wheels 20 or tracks, configured to turn the machine 10 at a machine steering angle. As used herein, the machine steering angle is the actual steering angle of the machine 10 as determined by the angle of rotation of the ground engagement members 18 within the full rotational range of the ground engagement members 18. In addition, as used herein, the maximum machine steering angle is the maximum steering angle that the ground engagement members can physically access within their full rotational range. The machine 10 may further include a steering device 22, such as a steering wheel 24 or a joystick, configured to steer the ground engagement members 18 to turn the ground engagement members 18 to the machine steering angle in response to a force applied on the steering device 22 by a machine operator. The steering device 22 may be located in an operator cab 26, although it may be remotely located in some arrangements. In addition, the machine 10 may have one or more implements 28, such as a dump bed 30, blade, or bucket, configured to articulate between raised and lowered positions.

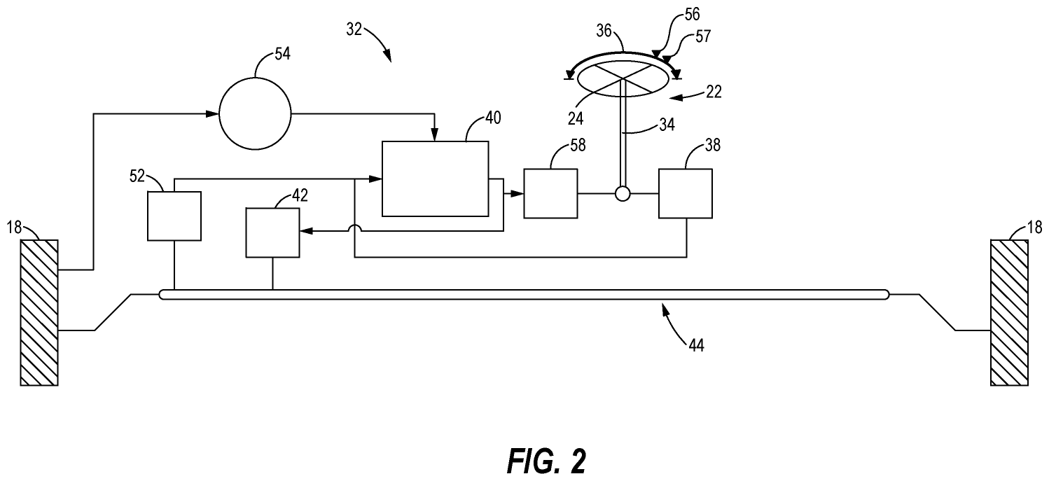

The machine 10 may further include a control system 32 for controlling the machine steering angle (also see FIG. 2). Specifically, the control system 32 may be configured to temporarily limit or reduce the maximum machine steering angle to a maximum permissible machine steering angle under varying operation conditions of the machine 10 to improve machine controllability and safety. As used herein, the maximum permissible machine steering angle may be a steering angle that is less than the maximum steering angle that the ground engagement members 18 are capable of reaching within their full rotational range. The maximum machine steering angle may be limited based on one more various operations conditions such as, but not limited to, machine speed, ground side slope, implement position, stability, obstacle avoidance, lateral acceleration, ground conditions, as well as other conditions known to those skilled in the art. It may be desirable, for example, to reduce the maximum machine steering angle at high machine speeds to prevent the machine from sliding laterally when turning. As another example, when the machine 10 is traveling on a side slope, it may be desirable to reduce the maximum machine steering angle in the uphill direction to prevent the machine 10 from tipping. Likewise, it may be desirable to reduce the maximum machine steering angle when the implement 28 is raised to prevent the machine 10 from tipping.

Referring to FIG. 2, the control system 32 may include the steering device 22 which may have the steering wheel 24 (or joystick) rotationally coupled to a steering column 34. The steering device 22 may be configured to move along a steering position range 36 in response to a force applied on the steering device 22 by the machine operator (also see FIG. 4). For example, if the steering device 22 includes the steering wheel 24, the steering position range 36 may be the full angular rotational range that is available to the steering wheel 24. The control system 32 may further include a steering position sensor 38 connected to the steering column 34 that monitors the position (e.g., the angular position) of the steering device 22 along the steering position range 36. Furthermore, the control system 32 may include an electronic control device 40 in communication with the steering position sensor 38 and a steering actuator 42 that actuates the turning of the ground engagement members 18 to the machine steering angle. The electronic control device 40 may receive signals from the steering position sensor 38 indicating the position of the steering device 22, and may transmit commands to the steering actuator 42 to actuate the turning of the ground engagement members 18 to the machine steering angle that corresponds to the position of the steering device 22.

The steering actuator 42 may actuate the turning of the ground engagement members 18 via a steering system 44. The steering actuator 42 may be a hydraulic actuator (e.g., hydraulic cylinders) or an electric motor that controls the movement of the ground engagement members via the steering system 44. The steering system 44 that is controlled by the steering actuator 42 may be an Ackermann steering system, an articulated system, a rack and pinion system, or other type of steering actuation system apparent to those with ordinary skill in the art. The electronic control device 40 may also be in communication with a steering angle sensor 52 that is mechanically connected to the steering system 44, to allow the electronic control device 40 to monitor the actual machine steering angle.

Notably, as seen in FIG. 2, the steering device 22 may be mechanically disconnected from the steering actuator 42 and the steering system 44, and the steering actuator 42 may be controlled based on commands from the electronic control device 40. As such, in some circumstances, the machine steering angle may be controlled according to commands from the electronic control device 40, independently of the steering device 22.

The electronic control device 40 may be in communication with one or more sensors 54 that monitor one or more operation conditions of the machine 10 such as, but not limited to, machine speed, ground side slope, implement position, stability, obstacle avoidance, lateral acceleration, terrain, ground conditions, as well as other conditions apparent to those with ordinary skill in the art. The electronic control device 40 may be in direct electronic communication with the sensor(s) 54, and/or information from the sensor(s) 54 may be communicated to the electronic control device 40 from other electronic control modules over a data link. Based on the machine operation conditions received from the sensor(s) 54, the electronic control device 40 may calculate the maximum permissible machine steering angle as well as a soft stop position 56 along the steering position range 36 that corresponds with the maximum permissible machine steering angle (also see FIGS. 4-5 and further details below). When the steering device 22 is rotated or moved to the soft stop position 56, the electronic control device 40 may transmit a command to a biasing member 58 to apply an opposing force on the steering device 22 to prevent further movement of the steering device 22 past the soft stop position 56. The biasing member 58 may be mechanically coupled to the steering column 34, and may apply an opposing torque on the steering column 34 that resists rotation of the steering device 22 past the soft stop position 56. In addition, the opposing force applied by the biasing member 58 may provide further functions such as, but not limited to, vibration dampening, suggesting or controlling the maximum rotation rate of the steering device 22, and indicating that the maximum rotation rate of the steering device 22 has been reached.

Additionally, the biasing member 58 may be further configured to apply an assisting force on the steering column 34 that assists the movement of the steering column 34/steering device 22. For example, the biasing member 58 may apply an assisting force on the steering column 34 to control the position of the steering device 22 during autonomous operation according to commands from the electronic control device 40. The biasing member 58 may be a torque motor, as well as other types of devices capable of applying an opposing force on the steering device 22 such as, but not limited to, brakes, electric motors, hydraulic motors, pneumatic motors, or combinations thereof. For example, the biasing member 58 may be a combination of torque motor and a brake.

A magnitude of the opposing force applied on the steering device 22 by the biasing member 58 may be sufficiently low such that the machine operator can physically move the steering device 22 past the soft stop position 56 if enough force is applied. That is, the opposing force may not enforce a hard physical limit to the position range of the steering device 22 but, rather, provide a notification to the operator that the maximum permissible machine steering angle under the current operation conditions has been reached. The opposing force may be overcome by the machine operator, allowing the machine operator to steer past the soft stop position 56. Should the machine operator inadvertently or intentionally steer the steering device 22 beyond the soft stop position 56, the electronic control device 40 and the steering actuator 42 may limit the machine steering angle to the maximum permissible machine steering angle independently of the position of the steering device 22 (see further details below). Likewise, if the biasing member 58 applies an assisting force on steering device 22, the magnitude of the assisting force may be overcome by the machine operator. For example, the machine operator may apply resistance to the assisting force to indicate that he or she wishes to assume steering control and terminate autonomous operation. The biasing member 58 may apply a torque (opposing or assisting) in the range of about 1 newton meters (N·m) to about 15 N·m on the steering column 34, although the force may deviate from this range in some circumstances depending on factors such as the application and/or type of operator input device used.

In addition, in some embodiments, the rotational range 36 of the steering device 22 may further include a hard stop position 57 past the soft stop position 56 beyond which further steering is precluded (see FIG. 2). At the hard stop position 57, the biasing member 58 may apply a higher force on the steering column 34 to enforce a hard limit against further rotation of the steering device 22. The force applied on the steering column 34 at the hard stop position 57 may be substantially greater than the force applied at the soft stop position 56 to restrict the operator from rotating the steering device 22 beyond the hard stop position. For instance, the force applied by the biasing member 58 at the hard stop position 57 may be greater than or substantially greater than 15 N·m.

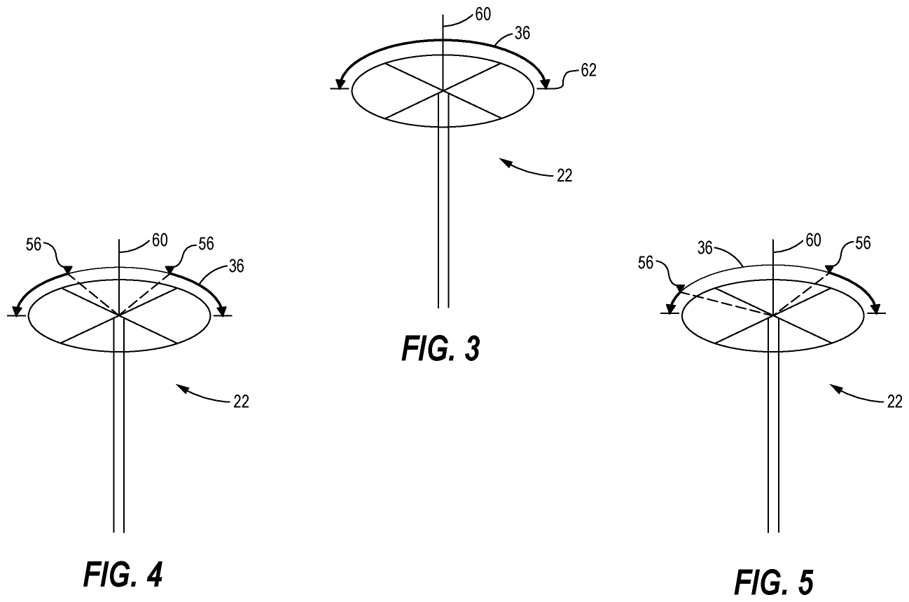

The steering position range 36 of the steering device 22 (without any soft stops) is schematically depicted in FIG. 3. FIG. 3 represents a condition in which the machine 10 is permitted to turn to the maximum machine steering angle, as dictated by the steering device 22, without limitations. The steering device 22 may be rotated to the right or the left with respect to a neutral positon 60 up to defined limits 62 that correspond with the maximum machine steering angle.

Turning to FIG. 4, soft stop positions 56 along the steering position range 36 are schematically depicted. FIG. 4 represents an exemplary condition in which the maximum machine steering angle is limited or reduced to a maximum permissible machine steering angle due to one or more operation conditions of the machine. In this example, the soft stop positions 56 are located at about 30° along the steering positional range 36 in the left and right directions with respect to the neutral position 60, however, it will be understood that the angles of the soft stop positions 56 may vary depending on the operation conditions of the machine 10. Before the steering device 22 reaches the soft stop position 56 in the left or right directions, the machine steering angle may be dictated by the position (e.g., angular position) of the steering device 22 according to a relationship which may or may not always be linear and may vary depending on operating conditions. That is, the electronic control device 40 may determine the position of the steering device 22 based on signals from the steering position sensor 38, and transmit a command to the steering actuator 42 to actuate rotation of the ground engagement members 18 to a machine steering angle that corresponds with the position of the steering device 22. When the steering device 22 is at or beyond the soft stop position 56, the machine operator may sense the opposing force on the steering device 22, signaling to the machine operator that the maximum permissible machine steering angle has been reached. In some arrangements, the opposing force may be applied on the steering device 22 a certain number of degrees before the soft stop position 56.

Referring still to FIG. 4, should the machine operator overcome the opposing force and move the steering device 22 beyond the soft stop position 56, the electronic control device 40 and the steering actuator 42 may fix the machine steering angle to the maximum permissible machine steering angle independently of the steering device 22. As such, the steering position range 36 of the steering device 22 may include a region before the soft stop positions 56 in which the steering device 22 controls the machine steering angle (thinly lined portion), and a region at or beyond the soft stop positions 56 in which the machine steering angle is fixed to the maximum permissible machine steering angle by the electronic control device 40 independently of the steering device 22 (thickly linked portion).

FIG. 5 schematically depicts a condition in which the soft stop positions 56 are asymmetrically disposed along the steering position range 36. The soft stop positions 56 may be asymmetrically disposed, for example, when the machine 10 is traveling on a side slope such that the machine 10 is more prone to tipping when the ground engagement members are turned in the uphill direction than in the downhill direction. It will be understood, however, that the soft stop positions 56 may be asymmetrically disposed for various other reasons as well. Furthermore, in some situations, only one side (the left side or right side) of the steering position range 36 will have a soft stop position 56.

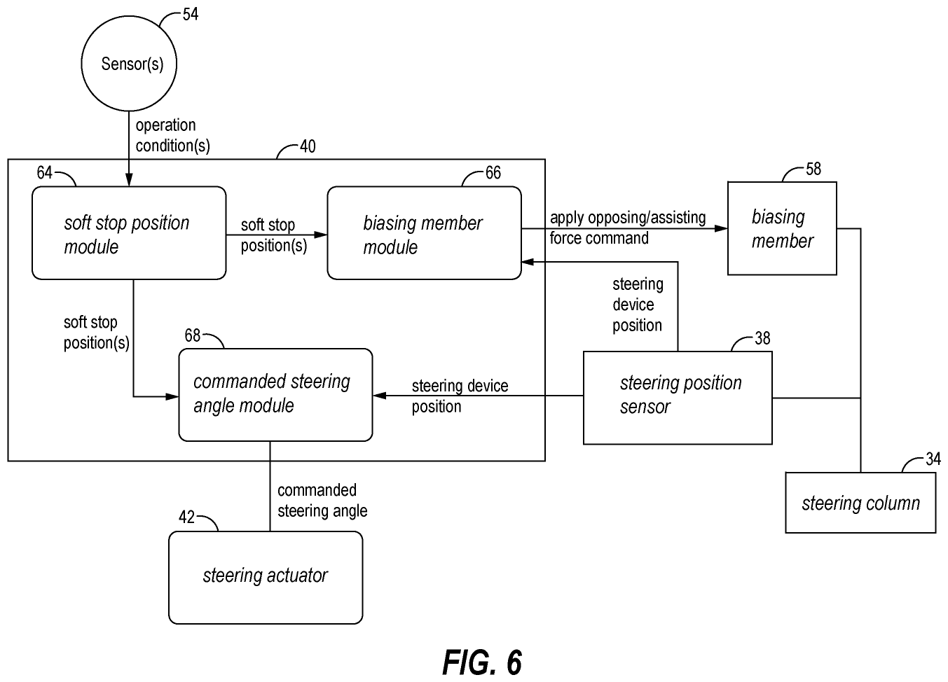

Referring to FIG. 6, the electronic control device 40 and its operations are schematically depicted. The electronic control device 40 may include a soft stop position module 64 that receives the machine operation conditions (including, but not limited to, machine speed, implement or bed position, ground side slope, machine payload, ground conditions (traction control or differential lock), position of obstacle or location to be avoided, dynamic stability of the machine, position with respect to other machines, position with respect to desired path or lane, etc.) from the one or more sensors 54, either directly or via a data link from other electronic controls. Based on the operation conditions, the soft stop position module 64 calculates the soft stop position(s) 56 along the steering position range 36 that correspond to a maximum permissible machine steering angle. The calculated soft stop postion(s) 56 may be output to a biasing member module 66 that sends a command to the biasing member 58 to apply the opposing force on the steering column 34 when the position of the steering device 22 is at or beyond the soft stop position 56. The biasing member module 66 may monitor the position of the steering device 22 based on signals from the steering position sensor 38.

The electronic control device 40 may also include a commanded steering angle module 68 that receives the calculated soft stop position(s) 56 from the soft stop position module 64. The commanded steering angle module 68 may monitor the position of the steering device 22 based on signals received from the steering position sensor 38, and determine a commanded steering angle based on the position of the steering device 22. The commanded steering angle may be identical to the machine steering angle, or it may correlate with the machine steering angle. Alternatively, the module 68 may determine a commanded change (including rate of change) in the steering angle that commands a change/rate of change in the machine steering angle based on the position of the steering device 22. The commanded steering angle module 68 may then command the steering actuator 42 to actuate the steering system 44 to turn the ground engagement members 18 to the machine steering angle that corresponds with the commanded steering angle. If the position of the steering device 22 is at or beyond the soft stop position 56, the commanded steering angle module 68 may limit the commanded steering angle to a maximum commanded steering angle that corresponds with the maximum permissible machine steering angle. As such, prior to the steering device 22 reaching the soft stop position 56, the machine steering angle is governed by the position of the steering device 22 by a relationship. After the steering device 22 is moved to or beyond the soft stop position 56, the machine steering angle is fixed at the maximum permissible machine steering angle by the electronic control device 40, so that the machine operator is precluded from turning the machine 10 beyond the maximum permissible machine steering angle that is deemed safe for the machine 10.

It will be understood that FIG. 6 shows one possible example of the module arrangement for the electronic control device 40. In alternative arrangements, the operations of the electronic control device 40 described above may be performed by a single module, or the operations may be shared among multiple modules.

### INDUSTRIAL APPLICABILITY

In general, the teachings of the present disclosure may find applicability in many industries including, but not limited to, construction, mining, and agricultural industries. For instance, the teachings of the present disclosure may be applicable to any industry relying on machines that may experience controllability or safety issues when the machines are steered beyond certain steering angles under certain operation conditions.

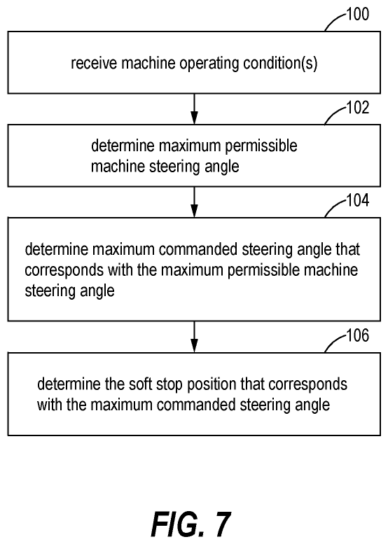

FIG. 7 shows a series of steps that may be involved in determining the soft stop position(s) 56 as performed by the electronic control device 40. According to a first block 100, the electronic control device 40 may receive signals indicative of one or more operation conditions of the machine 10 from the one or more sensors 54. Based on the operation conditions of the machine 10, the electronic control device 40 may calculate a maximum permissible machine steering angle that is deemed safe and/or supports the stability of the machine 10 under the operation conditions (block 102). In addition, the electronic control device 40 may determine the maximum commanded steering angle that correlates the maximum permissible machine steering angle (block 104), and determine the soft stop position(s) 56 that correspond with the maximum commanded steering angle (block 106). Accordingly, the soft stop position(s) 56 may be the position(s) along the steering position range 36 of the steering device 22 that provide the maximum permissible machine steering angle.

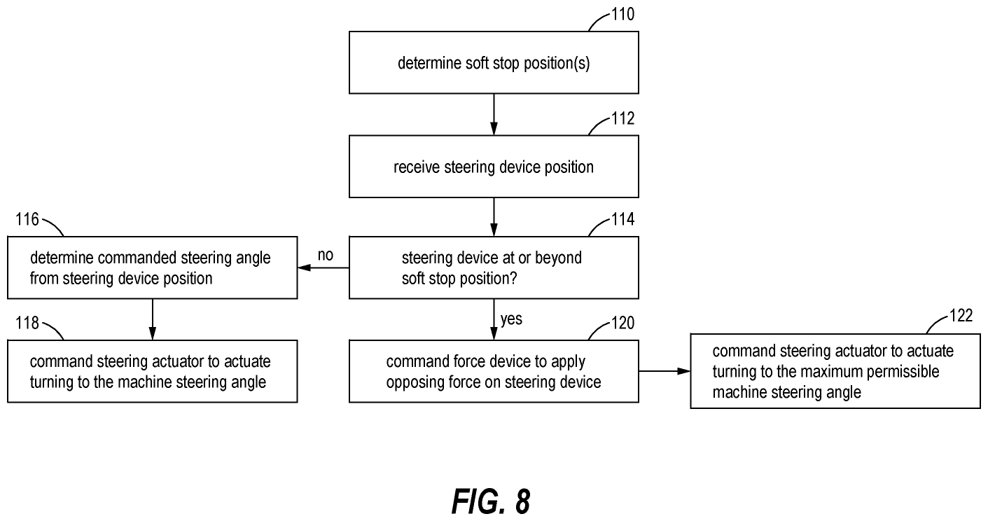

Turning now to FIG. 8, a method of controlling the machine steering angle of the machine 10 as performed by the electronic control device 40 is shown. At a first block 110, the electronic control device 40 may determine the soft stop position(s) 56 as described above in relation to FIG. 7. At a block 112, the electronic control device 40 may receive signals indicative of the position of the steering device 22 from the steering position sensor 38. The electronic control device 40 may then evaluate the position of the steering device 22 and determine whether the steering device 22 is at or beyond the soft stop position 56 (block 114). If the steering device 22 is not at or beyond the soft stop position 56, the electronic control device 40 may determine a commanded steering angle that correlates with the steering device position, and command the steering actuator 42 to actuate rotation of the ground engagement members 18 to the machine steering angle that corresponds with the commanded steering angle (blocks 116 and 118).

If it is determined that the position of the steering device 22 is at or beyond the soft stop position 56 during the block 114, then the electronic control device 40 may send a command to the biasing member 58 to apply the opposing force on the steering device 22 so that further movement or rotation of steering device 22 is resisted (block 120). In some arrangements, the electronic control device 40 may command the biasing member 58 to apply the opposing force on the steering device 22 when the position of the steering device 22 approaches or is near the soft stop position 56. In addition, in some arrangements, the opposing force may begin to increase as the soft stop position 56 is approached and may reach a maximum value as the soft stop position 56 is reached or crossed. Additionally, if the steering device 22 is at or beyond the soft stop position 56, the electronic control device 40 may command the steering actuator 42 to actuate the rotation of the ground engagement members 18 to the maximum permissible machine steering angle (block 122). It will be understood that the blocks 120 and 122 may be carried out in different orders or simultaneously. The methods of FIGS. 7-8 may be repeated as the operation conditions of the machine 10 change.

The machine steering angle control system disclosed herein dynamically controls machine steering angle based on one or more operation conditions that change during the operation of the machine. The control system limits or reduces the maximum machine steering angle to a maximum permissible machine steering angle to improve machine controllability and safety under certain operation conditions. When the steering device (steering wheel or joystick) of the machine is moved beyond a pre-determined position (soft stop position) that corresponds with the maximum permissible machine steering angle, an opposing force is applied on the steering device to notify the machine operator that the maximum permissible machine steering angle is reached. The machine operator may then release the force applied on the steering device. The opposing force does not enforce a hard limit and is of low enough magnitude such that the machine operator can move the steering device past the soft stop position by applying more force on the steering device. If the machine operator inadvertently or intentionally moves the steering device beyond the soft stop position, the electronic control device may limit the machine steering angle to the maximum permissible machine steering angle independently of the steering device. As opposed to prior art systems which enforce a hard limit to the movement or rotation of the steering device, the control system disclosed herein applies a soft limit that can be overcome by the machine operator if desired. As such, the biasing member may have a lower torque limit to reduce manufacturing costs, while also reducing operator effort and fatigue. Furthermore, since the opposing force applied by the biasing member may be less than what the machine operator is capable of applying, failure modes of the biasing member which produce incorrect forces on the steering device can be overcome by the machine operator to reduce safety concerns. Additionally, since the steering device is not mechanically linked to the steering actuator, the amount of change in machine steering angle in a failure mode may be reduced as well.

What is claimed is:

1. A machine, comprising:
a power source;
an implement configured to raise and lower a load;
ground engagement members configured to turn at a machine steering angle;
a steering actuator configured to actuate turning of the ground engagement members to the machine steering angle;
a steering device configured to move along a steering position range in response to a force applied on the steering device by a machine operator;
a steering position sensor configured to monitor a position of the steering device along the steering position range;
a biasing member mechanically coupled to the steering device and configured to apply an opposing force on the steering device that resists movement of the steering device when the steering device is at or beyond a soft stop position along the steering position range, a magnitude of the opposing force being sufficiently low such that the machine operator can move the steering device past the soft stop position; and
an electronic control device in communication with the steering actuator, the steering position sensor, and the biasing member, the electronic control device being configured to determine the soft stop position based on one or more operation conditions of the machine.

2. The machine of claim 1, wherein the steering device is mechanically disconnected from the steering actuator, and the steering actuator is controlled based on commands from the electronic control device.

3. The machine of claim 2, wherein the electronic control device is further configured to monitor the position of the steering device based on signals received from the steering position sensor, to determine a commanded steering angle that correlates with the machine steering angle based on the position of the steering device, to limit the commanded steering angle to a maximum commanded steering angle that correlates with a maximum permissible machine steering angle when the steering device is at or beyond the soft stop position, and to command the steering actuator to actuate turning of the ground engagement members to the machine steering angle that correlates with the commanded steering angle.

4. The machine of claim 3, wherein the electronic control device is in communication with one or more sensors that monitor the one or more operation conditions of the machine.

5. The machine of claim 4, wherein the electronic control device is configured to determine the soft stop position by determining the maximum permissible machine steering angle based on the one or more operation conditions of the machine, determining the maximum commanded steering angle that corresponds with the maximum permissible machine steering angle, and determining the soft stop position that corresponds with the maximum permissible machine steering angle.

6. The machine of claim 5, wherein the electronic control device is further configured to send a command to the biasing member to apply the opposing force on the steering device when the steering device is at or beyond the soft stop position.

7. The machine of claim 6, wherein the magnitude of the opposing force is between about 1 N·m and about 15 N·m.

8. The machine of claim 6, wherein the one or more operations conditions includes one or more of machine speed, ground side slope, and implement position.

9. The machine of claim 6, wherein the biasing member is one or both of a torque motor and a brake.

10. The machine of claim 6, wherein the steering device includes a steering wheel rotatably coupled to a steering column, and wherein the biasing member is mechanically coupled to the steering column.

11. A control system for controlling a steering angle of a machine, the machine including ground engagement members configured to turn at a machine steering angle, comprising:
a steering device configured to move along a steering position range in response to a force applied on the steering device by a machine operator;
a steering position sensor configured to monitor a position of the steering device along the steering position range;
a biasing member mechanically coupled to the steering device and configured to apply an opposing force on the steering device;
a steering actuator configured to actuate the turning of the ground engagement members to the machine steering angle, the steering device being mechanically disconnected from the steering actuator;
an electronic control device in communication with the steering position sensor, the steering actuator, and the biasing member, the electronic control device being configured to determine a commanded steering angle based on the position of the steering device and to command the steering actuator to actuate the turning of the ground engagement members to the machine steering angle that corresponds with the commanded steering angle, the electronic control device being further configured to determine a soft stop position along the steering device positional range, and to send a command to the biasing member to apply the opposing force when the steering device is at or beyond the soft stop position.

12. The control system of claim 11, wherein a magnitude of the opposing force is sufficiently low such that the machine operator can move the steering device past the soft stop position.

13. The control system of claim 11, wherein a magnitude of the opposing force is between about 1 N·m and about 15 N·m.

14. The control system of claim 12, wherein the electronic control device is in communication with one or more sensors that monitor one or more operation conditions of the machine, and wherein the electronic control device is further configured to determine the soft stop position based on the one or more operation conditions of the machine.

15. The control system of claim 14, wherein the electronic control device determines the soft stop position by determining a maximum permissible machine steering angle based on the one or more operation conditions of the machine, determining a maximum commanded steering angle that corresponds to the maximum permissible machine steering angle, and determining the soft stop position that corresponds with the maximum commanded steering angle.

16. The control system of claim 15, wherein the electronic control device is further configured to limit the commanded steering angle to the maximum commanded steering angle when the steering device is at or beyond the soft stop position so that the steering actuator actuates the turning of the ground engagement members to the maximum permissible machine steering angle when the steering device is at or beyond the soft stop position.

17. The control system of claim 16, wherein the biasing member is one or both of a torque motor and a brake.

18. A method for controlling a steering angle of a machine, the machine including a steering device configured to move along a steering position range in response to a force applied by a machine operator and ground engagement members configured to turn at a machine steering angle, comprising:
determining a soft stop position along the steering position range of the steering device based on one or more operation conditions of the machine;
receiving a signal indicating a position of the steering device along the steering device positional range;
determining whether the position of the steering device is at or beyond the soft stop position;
commanding a biasing member to apply an opposing force on the steering device that resists movement of the steering device when the steering device is at or beyond the soft stop position, a magnitude of the opposing force being sufficiently low such that the machine operator can move the steering device past the soft stop position; and
commanding the steering actuator to actuate turning of the ground engagement members to a maximum permissible machine steering angle when the steering device is at or beyond the soft stop position.

19. The method of claim 18, further comprising:
determining a commanded steering angle based on the position of the steering device when the position of the steering device is before the soft stop position; and
commanding the steering actuator to actuate turning of the ground engagement members to the machine steering angle that corresponds with the commanded steering angle when the position of the steering device is before the soft stop position.

20. The method of claim 18, wherein determining the soft stop position comprises:
determining the maximum permissible machine steering angle based on the one or more operation conditions of the machine; and
determining the soft stop position that corresponds to the maximum permissible machine steering angle.
